(19) United States
(12) Patent Application Publication
(10) Pub. No.: US 2025/0021554 A1
(43) Pub. Date: Jan. 16, 2025

(54) PATTERNED QUERY STATEMENTS WITH HINTS

(71) Applicant: SAP SE, Walldorf (DE)

(72) Inventors: Won Jun Chang, Seoul (KR); Youngbin Bok, Seoul (KR); Jaehyok Chong, Seoul (KR)

(73) Assignee: SAP SE, Walldorf (DE)

(21) Appl. No.: 18/351,191

(22) Filed: Jul. 12, 2023

(51) Int. Cl. G06F 16/2453

(52) U.S. Cl. CPC G06F 16/24542

(57) ABSTRACT

A computer implemented method can receive an incoming query statement and search a query hint registry for a patterned query statement that matches the incoming query statement. A wildcard expression contained in the patterned query statement matches one or more characters of the incoming query statement. The query hint registry includes a statement hint paired with the patterned query statement. Responsive to finding the patterned query statement that matches the incoming query statement, the method can append the statement hint to the incoming query statement, obtain a query execution plan for the incoming query statement appended with the statement hint, and execute the query execution plan.

### BACKGROUND

Queries (also referred to as “query statements”) are commands used in database management systems that request or instruct data retrieval. A query plan (also referred to as “query execution plan”) is a sequence of steps that a database management system (DBMS) executes in order to complete a query. When a query is run for the first time in the DBMS, the query can be compiled by a query optimizer to generate a corresponding query plan, which can be stored in memory called query plan cache, or simply plan cache. Thus, when the same query is run again, the DBMS does not need to regenerate the query plan. Instead, it can reuse the cached query plan stored in the query plan cache, thereby improving efficiency of the DBMS. Query optimization refers to the overall process of attempting to choose a most efficient query plan, among many candidate query plans, to execute a query.

Statement hints (or simply “hints”) in queries are special instructions or directives provided by users to the query optimizer, specifying how the query should be executed. The hints can provide additional information about the desired query plan, join order, index usage, parallelism, or other optimizations. By using hints, users can have more control over the query optimization process and guide the database engine towards the preferred approach for query execution. However, adding hints to individual queries can be tedious and error prone. Additionally, there is an increased complexity for processing queries with hints (e.g., in query parsing, cache management, etc.). Thus, there is room for improvement for optimizing queries with hints.

### BRIEF DESCRIPTION OF THE DRAWINGS

FIG. 1 is an overall block diagram of an example database management system supporting processing patterned query statements with hints.

FIG. 2 is a flowchart illustrating an example overall method of processing patterned query statements with hints.

FIG. 3 is depicts an example hint registry.

FIG. 4 is a diagram illustrating different actions that can be applied to hints paired with query statements.

FIG. 5 depicts some example query commands illustrating usages of patterned query statements with hints.

FIG. 6 depicts the effects of the query commands of FIG. 5.

FIG. 7 is a block diagram of an example computing system in which described embodiments can be implemented.

FIG. 8 is a block diagram of an example cloud computing environment that can be used in conjunction with the technologies described herein.

### DETAILED DESCRIPTION

### Example 1—Overview of Query Statements with Hints

Hints can play a specific role in query optimization by providing additional information or instructions to the query optimizer. For example, hints can serve as directives to the query optimizer, instructing it to choose a specific query execution plan. The query optimizer uses various algorithms and heuristics to determine the most efficient plan. But in some cases, the query optimizer may not make the optimal choice. This can happen, for example, upgrades to the query optimizer may cause changes to the compiled query execution plans, and some queries may regress in performance after such upgrades. Hints allow users to override the query optimizer's decision and guide it towards a preferred plan. For example, hints can also be used to influence the join order and/or join methods used by the query optimizer, which can impact the overall query performance. Additionally, hints can be used to guide the query optimizer in using specific indexes, applying specific query transformations, fine-tuning parallel query processing based on available system resources and workload characteristics, and so on.

For illustration purposes, query statements (with or without hints) written for SAP HANA database (provided by SAP SE of Walldorf, Germany) are used hereinafter as examples, although it is to be understood that the same principles described herein can be used for query statements (with or without hints) written for other databases.

Generally, hints can be added to query statements by using specific query commands (e.g., Alter command in SAP HANA) when users are running target queries. In existing technologies, users can add statement hints to literal queries or queries having specified objects, but not parameterized queries.

Literal queries are queries including literals (or constants) that are explicitly specified and not represented by parameters or identifiers. A literal can be a number, a character, a string, a Boolean value, a data and/or time value, etc. In other words, literal queries are unparameterized queries.

As an example, two literal queries Q1 and Q2 are listed below, in which constants (1234 and 4567) are specified in the where clause of the queries:
Q1 (without hint): select * from a where a=1234
Q2 (without hint): select * from a where a=4567

To add the hint NO_USE_HEX_PLAN for the queries Q1 and Q2, existing technologies allow a user to apply the Alter commands to the queries Q1 and Q2 individually, that is:
Q1 (with hint): alter system add statement hint (NO_USE_HEX_PLAN) for select * from a where a=1234
Q2 (with hint): alter system add statement hint (NO_USE_HEX_PLAN) for select * from a where a=4567

Some structured query language (SQL) query scripts (e.g., SQLScript of SAP HANA) can generate temporary tables to support complex data manipulation and processing within the scripts. Temporary tables are created during runtime and exist only during execution of the scripts. Temporary tables can be used to store and manipulate intermediate results, temporary data sets, or aggregates, allowing for more efficient and organized data processing.

As an example, a SQLScript can generate the following two queries Q3 and Q4 with respective temporary tables (temp_01234 and temp_12412). Each temporary table can be created with a different name each time the SQLScript is executed.
Q3 (without hint): select * from temp_01234 where a=10
Q4 (without hint): select * from temp_12412 where a=10

Similarly, to add the hint NO_USE_HEX_PLAN statement hint for the queries Q3 and Q4, existing technologies allow a user to apply the Alter commands to the queries Q3 and Q4 individually:
Q3 (with hint): alter system add statement hint (NO_USE_HEX_PLAN) for select * from temp_01234 where a=10
Q4 (with hint): alter system add statement hint (NO_USE_HEX_PLAN) for select * from temp_12412 where a=10

Although existing technologies allow users to add hints to literal queries or queries including names of temporary objects (e.g., temporary tables), such hints can only be added individually for those queries, that is, a separate Alter command must be written for each literal query or each query including a temporary object. Such a process of adding hints to queries is not only inefficient and time consuming, but also is prone to human errors (e.g., due to typos).

Further, queries with hints can increase the complexity of query processing. For example, a query parser needs to differentiate queries with and without hints. Additionally, management of plan cache can be complicated because the query optimizer can generate different query plans for the same incoming query with and without a hint, which can impact the decision making on which query plan should be saved in the plan cache (and which query plan in the plan cache should be evicted).

The technologies described herein provide a system and method for more efficient handling of query statements with hints. As described more fully below, the technologies described herein support using patterned query statements with hint, which allows users to “parameterize” literal queries and/or queries including temporary object names (e.g., generated by running an SQL script) by using wildcard expressions. Each wildcard expression can serve as a placeholder and represent a plurality of literals or a plurality of temporary object names. Users can add hints to these “parameterized” queries, instead of to each individual query separately. This feature can vastly increase the usability of statement hints and extend the scope where the hints can be used in query processing.

### Example 2—Example Database Management System Supporting Patterned Query Statements with Hints

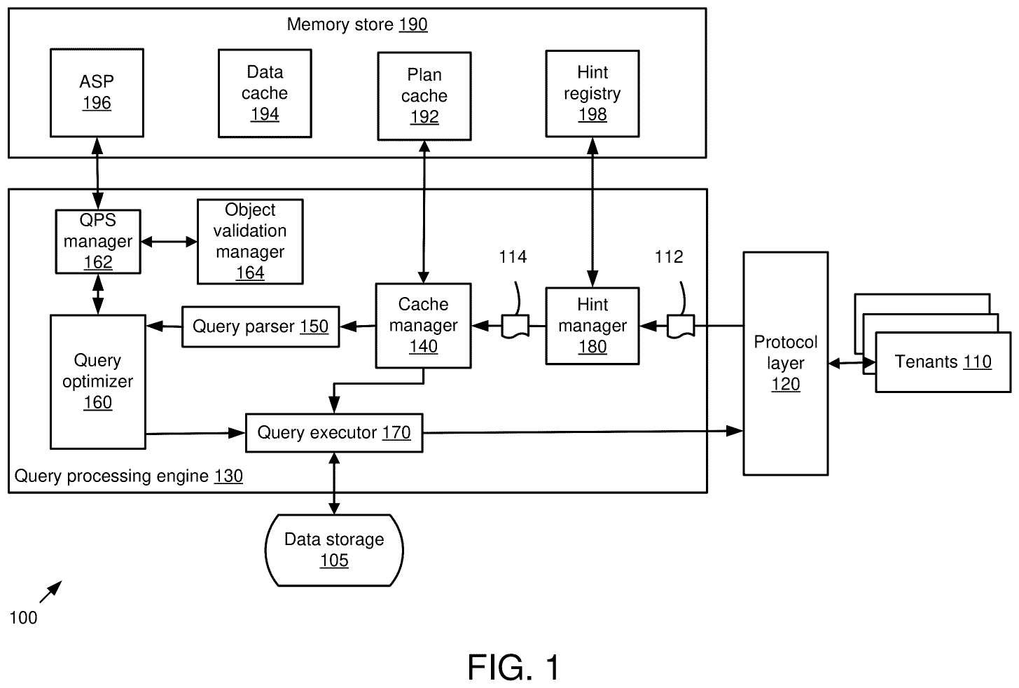

FIG. 1 shows an overall block diagram of an example database management system 100 which supports processing patterned query statements with hints.

The database management system 100 can be configured to support multi-tenancy. As shown, the database management system 100 includes a query processing engine 130 and a protocol layer 120 which serves as an interface between one or more tenants 110 and the query processing engine 130. For example, the protocol layer 120 can implement a server name indication protocol by which the tenants 110 can connect to the query processing engine 130. Each tenant 110 represents a group of users who can access a tenant-specific database managed by the database management system 100.

The query processing engine 130 can include a cache manager 140, a query parser 150, a query optimizer 160, a query executor 170, and a hint manager 180. The cache manager 140 can access a plan cache 192 in a memory store 190. The plan cache 192 represents a fast-access memory space configured to store previously compiled query plans.

An incoming query 112 sent from a tenant 110 can be processed by the hint manager 180 to output a query 114, which can be the same as or different from the incoming query 112. The hint manager 180 maintains a query hint registry 198 (or simply “hint registry”), which can be located in the memory store 190. The hint registry 198 can include one or more pairs of query statements and corresponding hints (i.e., each query statement in the hint registry 198 has a paired hint). The query statements stored in the hint registry 198 can be patterned (e.g., with wildcard expressions) or non-patterned (e.g., literal queries, queries including explicit object names, etc.).

Some of the incoming queries 112 can include hint commands, such as commands for adding a hint, removing a hint, enabling a hint, disabling a hint, etc. Based on the received hint commands, the hint manager 180 can update the hint registry 198. For example, responsive to receiving a command to add a hint to a query statement, the hint manager 180 can add the pair of query statement and the hint to the hint registry 198. Conversely, responsive to receiving a command to remove hint(s) for a query statement, the hint manager 180 can delete the pair of query statement and the corresponding hint(s) from the hint registry 198. The hint manager 180 can also enable or disable hint(s) registered in the hint registry 198 based on the received hint commands.

The hint manager 180 can be configured to perform a preliminary grammar check for the incoming queries 112. For example, the hint manager 180 can check if any of the hint commands contains syntactic and/or semantic errors. In some implementations, the patterned query statements can only be used in conjunction with the hints. Thus, if the hint manager 180 finds that the incoming query 112 is a data retrieval command (e.g., a Select statement) which includes a wildcard expression, the hint manager 180 can throw an error.

The hint manager 180 is also configured to search the hint registry 198 to identify if an incoming query 112 matches one of the query statements stored in the hint registry 198. If a matching query statement is found, the corresponding hint can be appended (or added) to the incoming query 112. In other words, the incoming query 112 is modified by the hint paired with the matching query statement. The modified query (i.e., the incoming query 112 appended with the hint) is propagated downstream of the hint manager 180, e.g., processed by the cache manager 140, query parser 150, query optimizer 160, etc. On the other hand, if no matching query statement is found, the incoming query 112 is not modified, and can be directly passed to the cache manager 140 for query processing.

The hint manager 180 can use string comparison to determine if the incoming query 112 matches any of the query statements. For each patterned query statement stored in the hint registry 198, a wildcard expression contained in the patterned query statement can match one or more characters of the incoming query when performing the string comparison.

The cache manager 140 receives the query 114 (which can be the incoming query 112 appended with a hint or the unmodified incoming query 112) sent from the hint manager 180. The cache manager 140 can evaluate the received query 114 to determine if the query 114 has a corresponding (compiled) query execution plan stored in the plan cache 192.

If the cache manager 140 finds no query execution plan in the plan cache 192 that corresponds to the query 114, the query 114 can be analyzed by the query parser 150, which can check if the query 114 contains syntactic and/or semantic errors. After verifying that the query 114 is a valid transactional SQL statement (e.g., SELECT, INSERT, UPDATE, DELETE, MERGE, etc.), the query parser 150 can generate a logical tree in which the query 114 can be executed.

The logical tree can be used by the query optimizer 160 to generate a corresponding query execution plan, which determines how the query 114 will be executed. The query optimizer 160 is configured to select a query execution plan (among a plurality of query execution plans that are generated based on enumeration of the logical tree) that yields optimal performance. Performance of a query execution plan can be described in terms of cost, which can be time (e.g., time required to execute the query execution plan) and/or burden on computing resources (e.g., processing power and/or memory expended to execute the query execution plan). Cost-based query optimization chooses the query execution plan with the lowest cost among all candidate query execution plans. In practice, although the terms “optimal” and “optimize” are used, the actual best query execution plan may not be selected, but the selected query execution plan is deemed better than others based on data available to the query optimizer 160.

The determined optimal query execution plan can then be sent to the query executor 170 for execution. The query executor 170 can communicate with a data storage or memory space 105 and execute operators in the query execution plan determined by the query optimizer 160. Data retrieved from the data storage or memory space 105 can be returned to the tenant 110 via the protocol layer 120.

As described herein, query compilation refers to the process of converting a query 114 to the optimal query execution plan (e.g., checking syntactic and/or semantic errors, generating the logical tree, and determining optimal query execution plan), as described above. Depending on the complexity of the query 114 (e.g., the number of joined tables, etc.) and the query optimization algorithm, query compilation time can be long (e.g., tens of seconds or more). Thus, to improve operational efficiency, the compiled query execution plan (i.e., the determined most optimal query execution plan) corresponding to the query 114 can be stored in the plan cache 192 so that it can be quickly retrieved and reused if the same query is encountered again in the future.

For example, if the cache manager 140 determines that the query 114 has a corresponding query execution plan stored in the plan cache 192, that query execution plan can be fetched directly from the plan cache 192 and forwarded to the query executor 170 for execution. Thus, in this scenario, operations by the query parser 150 and query optimizer 160 can be bypassed. In other words, the query 114 does not need to be recompiled because its previously compiled query execution plan is available in the plan cache 192.

As noted above, the plan cache 192 can store compiled query execution plans. For each received query 114, the cache manager 140 checks if it has a compiled query execution plan stored in the plan cache 192. If yes, then this cached query execution plan can be reused. This can improve efficiency because it eliminates the time of compiling the query 114 (i.e., regenerating the query execution plan). On the other hand, if the query 114 has no compiled query execution plan stored in the plan cache 192, the query 114 has to be compiled. The compiled query execution plan can then be stored in the plan cache 192 so that when the same query 114 occurs again in the future, fast access to its cached query execution plan is feasible.

If the received query 114 is new (i.e., a first-time query that has not been encountered before), this new query has no corresponding query execution plan in the plan cache 192 and it must be compiled for the first time. On the other hand, if the received query 114 is old (i.e., the same query has been encountered at least once before), whether or not there is a corresponding compiled query execution plan in the plan cache 192 can depend on the size of the plan cache 192 and a plan eviction policy adopted by the cache manager 140.

The plan cache 192 has a limited size. Thus, it may not be able to store all compiled query execution plans. When the plan cache 192 approaches its full capacity, certain query execution plans may have to be evicted (i.e., removed) from the plan cache 192 to make room for new ones according to a predefined plan eviction policy implemented by the cache manager 140. For example, the cache manager 140 can implement a random plan eviction policy which evicts query execution plans from the plan cache 192 in a random manner. In another example, the cache manager 140 can implement the least recently used (LRU) plan eviction policy which removes the least recently used query execution plans first from the plan cache 192. In yet another example, the least frequently used (LFU) plan eviction policy can be used which first evicts the execution policies that are used least often. Many other plan eviction policies can also be used by the cache manager 140.

If the received query 114 includes hint commands (e.g., commands for adding a hint, removing a hint, enabling a hint, disabling a hint, etc.), the cache manager 140 can be configured to perform additional operations on the plan cache 192 (e.g., evicting one or more query execution plans), as described more fully below.

In certain circumstances, performance regression of query execution plans can occur, e.g., due to a system upgrade and/or data change of the database management system 100. To mitigate potential performance regression of query plans, the query optimizer 160 can be configured to capture selected query plans and reuse them if necessary to regenerate the original query plans so as to retain the original performance. The captured query plans can be stored in an abstract SQL plan (ASP) store 194. In the depicted example, the ASP store 194 resides in the memory store 190. In other examples, the ASP store 194 can be stored in a persistence layer and loaded into the memory if needed. The ASP can also be generally referred to as the “abstract query plan.”

In practice, the systems shown herein, such as system 100, can vary in complexity, with additional functionality, more complex components, and the like. For example, there can be additional functionality within the query processing engine 130. Additional components can be included to implement security, redundancy, load balancing, report design, and the like.

The described computing systems can be networked via wired or wireless network connections, including the Internet. Alternatively, systems can be connected through an intranet connection (e.g., in a corporate environment, government environment, or the like).

The system 100 and any of the other systems described herein can be implemented in conjunction with any of the hardware components described herein, such as the computing systems described below (e.g., processing units, memory, and the like). In any of the examples herein, the query statements, the hints, the query plans, and the like can be stored in one or more computer-readable storage media or computer-readable storage devices. The technologies described herein can be generic to the specifics of operating systems or hardware and can be applied in any variety of environments to take advantage of the described features.

### Example 3—Example Overall Method of Processing Patterned Query Statements with Hints

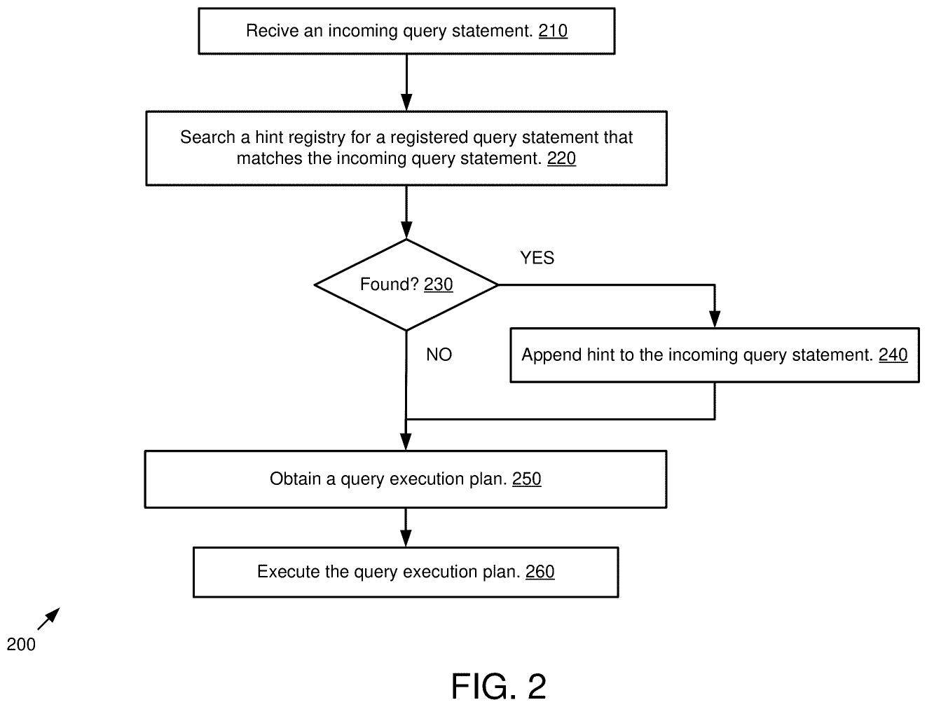

FIG. 2 is a flowchart illustrating an example overall method 200 of processing patterned query statements with hints, and can be performed, for example, by the query processing engine 130 of FIG. 1.

At 210, an incoming query statement (e.g., the incoming query 112) can be received, e.g., by the hint manager 180.

At 220, a hint registry (e.g., the hint registry 198) can be searched (e.g., by the hint manager 180) to identify a registered query statement that matches the incoming query statement. As described above, the hint registry can include one or more pairs of query statements and corresponding hints. Some of the query statements in the hint registry can be patterned, that is, having wildcard expressions, as described more fully below.

At 230, a condition check can be performed. If it is found that a registered query statement matches the incoming query statement, the method can proceed to 240, where the hint paired with the matching registered query statement can be appended to the incoming query statement (e.g., by the hint manager 180). Thus, the output of the hint manager is a modified query (e.g., the query 114) which combines the incoming query statement with the hint. On the other hand, if no registered query statement matches the incoming query statement, the incoming query statement will remain unmodified, that is, the output of the hint manager (e.g., the query 114) is identical to the incoming query statement.

At 250, a query execution plan can be obtained for the query (e.g., the query 114) output from the hint manager. In some examples, the query execution plan can be generated by a query optimizer (e.g., the query optimizer 160). In some examples, the query execution plan was previously generated and can be retrieved from a plan cache (e.g., the plan cache 192). In general, the query execution plan for the incoming query statement (e.g., the query 112) is different from the query execution plan for the incoming query statement appended with a hint (e.g., the query 114) because the hint can provide additional information or instructions to the query optimizer.

Then, at 260, the query execution plan can be executed (e.g., by the query executor 170).

The method 200 and any of the other methods described herein can be performed by computer-executable instructions (e.g., causing a computing system to perform the method) stored in one or more computer-readable media (e.g., storage or other tangible media) or stored in one or more computer-readable storage devices. Such methods can be performed in software, firmware, hardware, or combinations thereof. Such methods can be performed at least in part by a computing system (e.g., one or more computing devices).

The illustrated actions can be described from alternative perspectives while still implementing the technologies. For example, “receive” can also be described as “send” from a different perspective.

### Example 4—Example Wildcard Expressions in Patterned Query Statements with Hints

As described above, query statements stored in the hint registry can be patterned or non-patterned. As described herein, a patterned query statement includes a wildcard expression, whereas a non-patterned is absent of a wildcard. A wildcard expression can be a special character or sequence of characters that matches any character or set of characters in a string. In the examples described hereinafter, a special syntax is used, by which a wildcard expression is enclosed within two pairs of double dollar signs ($$). It is to be understood that such syntax is merely one example implementation, and the wildcard expression can be denoted by other tokens.

A typical SQL query for data retrieval is the SELECT statement, which includes a FROM clause and a WHERE clause. The FROM clause specifies the table or tables from which the data will be retrieved, e.g., by specifying the table name or names. The WHERE clause is used to filter the data returned by the query based on specified conditions, e.g., by specifying criteria or expressions that must be satisfied for a row to be included in the query result. As described herein, for a patterned SELECT statement, the wildcard expression can appear in the WHERE clause, the FROM clause, or both the WHERE and FROM clauses.

In one example, the wildcard expression can include a predefined symbol that matches any constants or literals represented by one or more characters of a query. For example, when doing string comparison between a patterned query statement and a query, the wildcard expression $$?$$ in the patterned query statement can match any literals (e.g., 1234, 1234.123, 123E10, ‘abc,’ ‘ab′c,’ etc.) appearing in corresponding position of the query. In this example, the predefined symbol used in the wildcard expression is a question mark “?”. In other examples, other symbols can be used (e.g., an asterisk mark “*”, etc.).

In another example, the wildcard expression can include a set of constants. When doing string comparison between a patterned query statement and a query, a literal (represented by one or more characters) appearing in corresponding position of the query can be matched to the wildcard expression if the literal in the query is identical to any constant in the set. For example, the wildcard expression $${0, 1, 2}$$ defines a set of three constants 0, 1, and 2. This wildcard expression can be matched to 0, 1, or 2 appearing in corresponding position of the query. In this example, curly brackets are used define a set of constants in the wildcard expression. In other examples, other symbols can be used denote a set of constants.

In another example, the wildcard expression can include a range defined by a minimum value (min) and a maximum value (max). When doing string comparison between a patterned query statement and a query, a literal (represented by one or more characters) appearing in corresponding position of the query can be matched to the wildcard expression if the literal in the query is within the range defined by the wildcard expression. For example, the wildcard expression $$ (0, 10) $$ defines a range between 0 and 10. This wildcard expression can match any literals within range (0, 10) and appearing in corresponding position of the query. As described herein, the range defined in a wildcard expression can be an open range (e.g., enclosed within two parentheses, or (min, max)), or a closed range (e.g., enclosed within two square brackets, or [min, max]), or a half-bounded range (e.g., enclosed within a parenthesis and a square bracket, or [min, max) or (min, max]). Other notations can be used to define the range in a wildcard expression.

In yet another example, the wildcard expression can include a partial string combined with a wildcard template. In some examples, the wildcard template can be enclosed within a pair of curly brackets { }. In other examples, the wildcard template can be denoted by other tokens. In some examples, the wildcard template can include a symbol (e.g., a question mark “?”) which can match any literals. For instance, a wildcard expression $$TEMP_{?}$$ defines a partial string “TEMP_” and the wildcard template “?”. This wildcard expression can match any literals that start with the string “TEMP_” (e.g., TEMP_01234, TEMP_12412, TEMP_A01Z, etc.) and appear in corresponding position of the query. In some examples, the wildcard template can include a predefined datatype which can match any literals having such datatype. Example datatypes include NUMBER, DATE, TIME, TIMESTAMP, or other datatypes that are supported by the database system. For instance, a wildcard expression $$TAB {DATE}$$ defines a partial string “TAB” and the wildcard template DATE. This wildcard expression can match any literals that start with the string “TAB” and followed with a date (e.g., TAB2023-06-10, TAB05JUL2022, etc.). In some examples, the wildcard template can include a set of constants or a range, similar to the examples described above.

### Example 5—Example Hint Registry

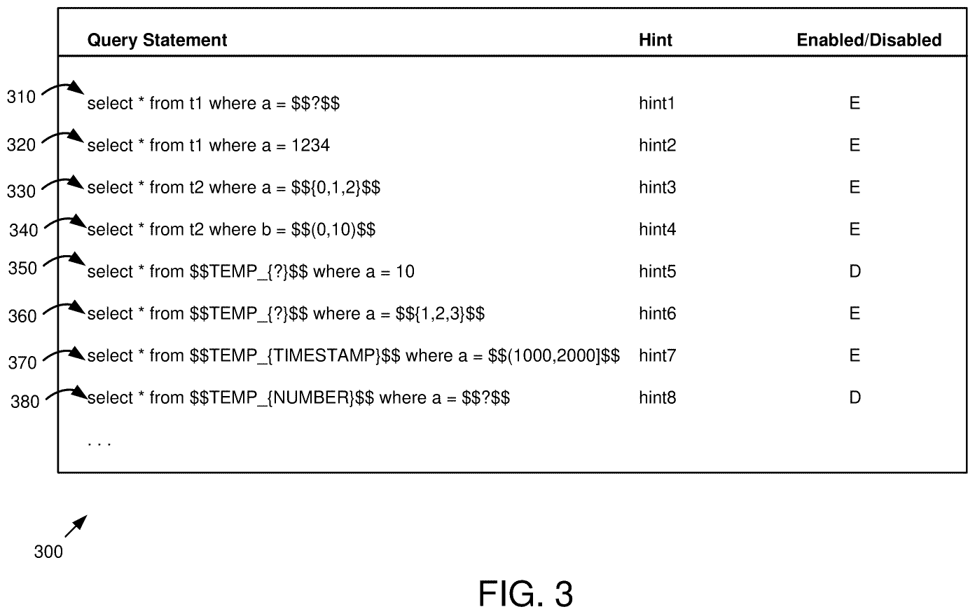

FIG. 3 depicts an example hint registry 300, which includes a plurality of entries (e.g., 310-380). Each entry in the hint registry 300 includes a pair of query statement and a corresponding hint.

In some examples, the hint for query statement can be enabled (E) or disabled (D), e.g., according to a Boolean flag associated with the entry. As described herein, when a hint paired with a query statement is disabled, the hint is prevented from being appended to an incoming query (e.g., the incoming query 112 in FIG. 1) even if the incoming query matches the query statement stored in the hint registry. Conversely, when a hint paired with a query statement is enabled, the hint is allowed to be appended to the incoming query if the incoming query matches the query statement stored in the hint registry.

As described above, the query statements in the hint registry 300 can be patterned (i.e., including a wildcard expression) or non-patterned (i.e., without a wildcard expression). In the depicted example, the query statement in the entry 320 is non-patterned, whereas the query statements in other entities are patterned. As shown, wildcard expressions are included in the WHERE clauses of query statements in entries 310, 330, 340, 360, 370, and 380. Additionally, wildcard expression are also included in the FROM clauses of query statements in entries 350, 360, 370, and 380.

As described above, if an incoming query matches one of the query statements in the hint registry 300, the hint paired with that query statement can be appended to the incoming query (assuming the hint is enabled). For example, entry 360 includes a wildcard expression $$TEMP_{?}$$ in the FROM clause and another wildcard expression $${1, 2, 3}$$ in the WHERE clause of the SELECT statement. Thus, any of the following incoming queries will be found to match the query statement in entry 360:
Select * from TEMP_01234 where a=1
Select * from TEMP_12412 where a=2
Select * from TEMP_A10Z where a=3

As a result, hint6 will be appended to each of those incoming queries.

### Example 6—Example Hint Priority Management

In some examples, an incoming query (e.g., the incoming query 112 in FIG. 1) may be found to match two or more query statements in the hint registry. In such circumstances, non-patterned query statements can have a higher priority than patterned query statements, that is, hints paired with the non-patterned query statements are appended to the incoming query. Such priority management assumes that hints paired with non-patterned query statements are more specific and desired by the user. For example, assuming an incoming query is: Select * from t1 where a=1234. This incoming query can be found to match both the patterned query statement in entry 310 and the non-patterned query statement in entry 320. Thus, hint2 (rather than hint1) will be appended to the incoming query.

In cases where an incoming query matches two different patterned query statements in the hint registry, hint enablement/disablement and/or predefined rules can be used to select which hint should be appended to the incoming query. For example, assuming an incoming query is: Select * from TEMP_0152 where a=2. This incoming query can be found to match both the patterned query statement in entry 360 and the patterned query statement in entry 380. In the depicted example, hint6 (in entry 360) is enabled whereas hint8 (in entry 380) is disabled. Thus, hint6 will be appended to the incoming query. If hint8 is also enabled, hint6 can still be appended to the incoming query according to a predefined rule which selects the hint associated with the first patterned query statement that matches the incoming query.

### Example 7—Example Actions on Hints

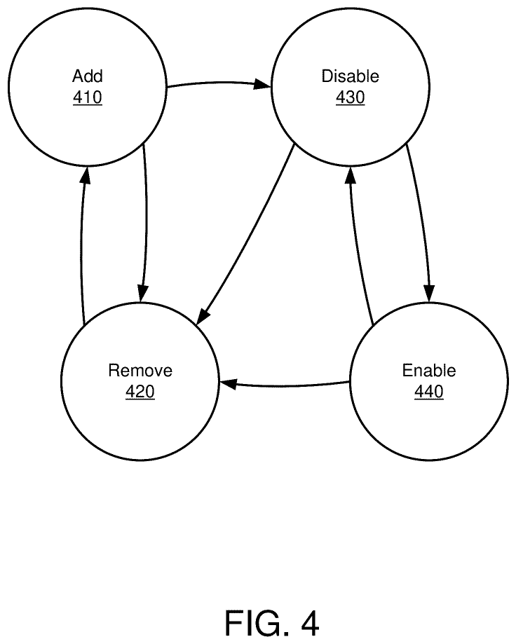

FIG. 4 depicts actions that can be applied to hints paired with query statements, and state transitions between those actions. Example actions include adding (or registering) a hint to the hint registry 410, removing a hint from the hint registry 420, disabling a hint in the hint registry 430, and enabling a hint in the hint registry 440. These actions can be handled or performed by a hint manager (e.g., the hint manager 180).

In FIG. 4, the arrows indicate some possible sequences of these actions. For example, after a hint is added to the hint registry, the hint can be removed or disabled. A disabled hint can be enabled or removed from the hint registry. An enabled hint can be disabled or removed from the hint registry. A removed hint can be added back to the hint registry.

In some examples, a user can provide a hint command to register a query statement and a paired hint in the hint registry. The hint command can specify a particular hint to be appended to a specific query statement, which can be patterned or non-patterned. For example, a user can use the following “alter system add statement hint” command to register a new entry in the hint registry:
alter system add statement hint (no_use_hex_plan) for select * from t1 where a=$$?$$

Specifically, this hint command can cause the hint manager to add a patterned query “select * from t1 where a=$$?$$” and a paired hint “no_use_hex_plan” to the hint registry. By default, the newly added hint in the hint registry can be automatically enabled.

In some examples, a user can provide a hint command to remove an entry (including a query statement and the paired hint) from the hint registry. For example, a user can use the following “alter system remove statement hint” command:
alter system remove statement hint for select * from t1 where a=$$?$$

This hint command can remove the hint that is paired with the query statement “select * from t1 where a=$$?$$” from the hint registry. In some examples, the hint manager may allow a query statement to be paired with two or more hints, e.g., by enabling one of the hints while disabling the other hints. In such case, the above hint command can remove all hints paired with the query statement “select * from t1 where a=$$?$$” from the hint registry.

In some examples, a user can provide a hint command to disable a hint paired with a query statement in the hint registry. For example, a user can use the following “alter system disable statement hint” command:
alter system disable statement hint for select * from t1 where a=$$?$$

This hint command can disable the hint that is paired with the query statement “select * from t1 where a=$$?$$” in the hint registry. In cases that a query statement is allowed to be paired with two or more hints, the above hint command can disable all hints paired with the query statement “select * from t1 where a=$$?$$” in the hint registry.

In some examples, a user can provide a hint command to enable a hint paired with a query statement in the hint registry. For example, a user can use the following “alter system enable statement hint” command:
alter system enable statement hint for select * from t1 where a=$$?$$

This hint command can enable the hint that is paired with the query statement “select * from t1 where a=$$?$$” in the hint registry.

### Example 8—Example Usage of Patterned Query Statements with Hints

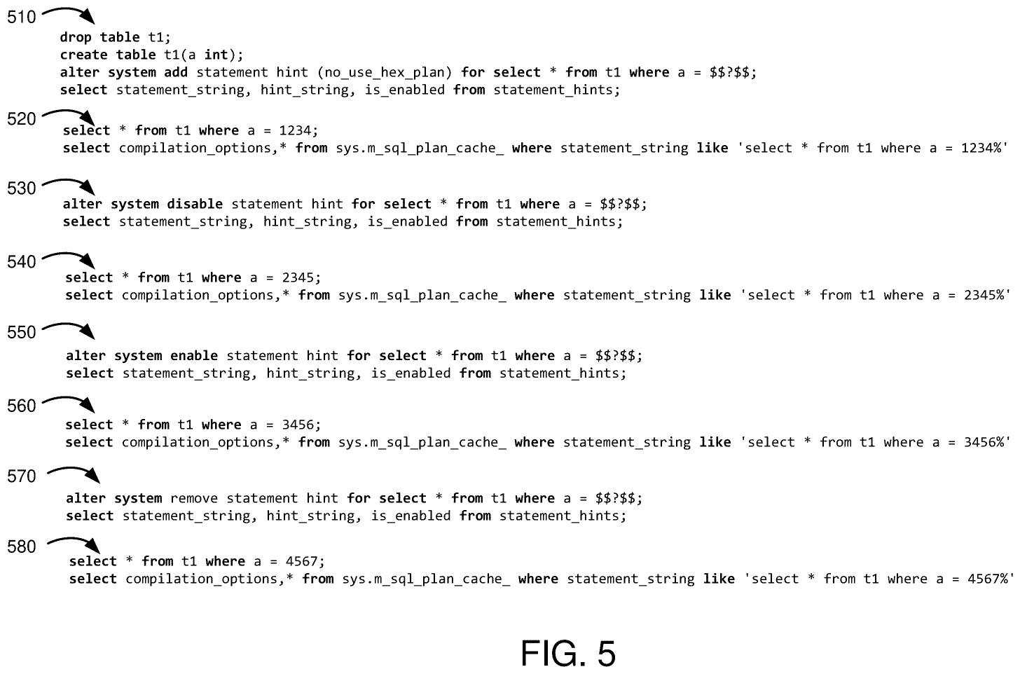

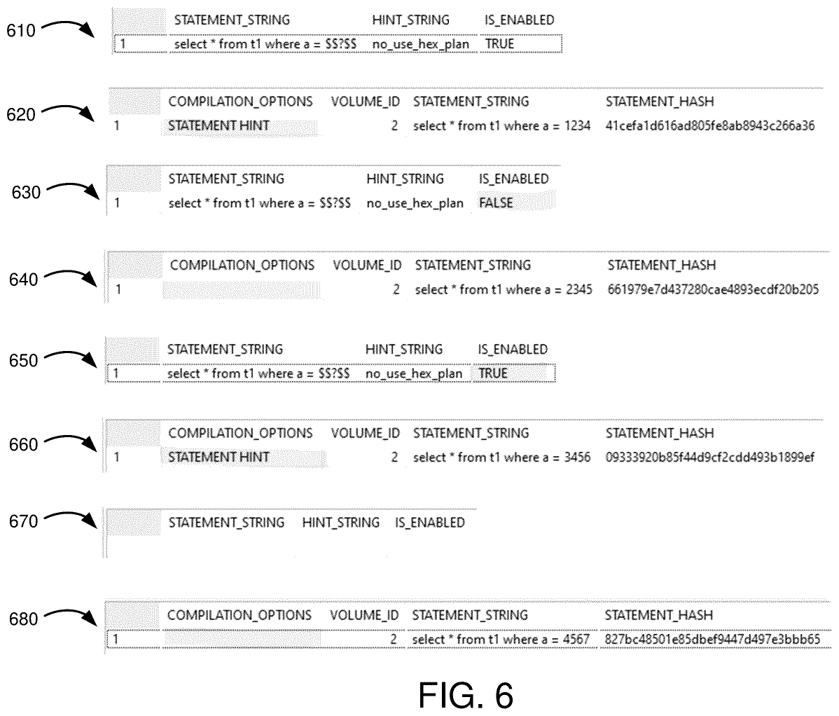

For illustration purposes, FIG. 5 depicts some example query commands involving patterned query statements with hints, and FIG. 6 depicts the effects of these query commands by presenting some internal results as the hint manager processes the patterned query statements with hints.

In a first group of query commands 510, a table named t1 is dropped and then re-created. Then an “alter system add statement hint” hint command is used to add a hint “no_use_hex_plan” to a patterned query statement “select * from t1 where a=$$?$$.” The next SELECT statement checks if the hint is added to the hint registry. The result of this SELECT statement is shown in table 610 of FIG. 6, which lists the new entry added to the hint registry, which includes the patterned query statement “select * from t1 where a=$$?$$” and the paired hint “no_use_hex_plan.” Also, this newly added hint is automatically enabled (IS_ENABLED=TRUE), as described above.

In a second group of query commands 520, an incoming query “select * from t1 where a=1234” is received and processed. The next SELECT statement checks if any compilation options are applied to the incoming query. The result is shown in table 620 of FIG. 6, which confirms that a hint is appended to the incoming query. In this example, the hint would be “no_use_hex_plan” because the incoming query matches the patterned query statement “select * from t1 where a=$$?$$” stored in the hint registry.

In a third group of query commands 530, an “alter system disable statement hint” hint command is used to disable the hint paired with the patterned query statement “select * from t1 where a=$$?$$.” The next SELECT statement checks if the hint is disabled. As shown in table 630 of FIG. 6, the hint “no_use_hex_plan” paired with the patterned query statement “select * from t1 where a=$$?$$” is indeed disabled (IS_ENABLED=FALSE).

In a fourth group of query commands 540, another incoming query “select * from t1 where a=2345” is received and processed. The next SELECT statement checks if any compilation options are applied to the incoming query. The result is shown in table 640 of FIG. 6, which shows that no hint is appended to the incoming query (e.g., the column of COMPILATION_OPTIONS is empty). This is because the hint paired with the patterned query statement “select * from t1 where a=$$?$$” is disabled, even though the incoming query “select * from t1 where a=2345” matches the patterned query statement.

In a fifth group of query commands 550, an “alter system enable statement hint” hint command is used to enable the hint paired with the patterned query statement “select * from t1 where a=$$?$$.” The next SELECT statement checks if the hint is enabled. As shown in table 650 of FIG. 6, the hint “no_use_hex_plan” paired with the patterned query statement “select * from t1 where a=$$?$$” is indeed enabled (IS_ENABLED=TRUE).

In a sixth group of query commands 560, another incoming query “select * from t1 where a=3456” is received and processed. The next SELECT statement checks if any compilation options are applied to the incoming query. The result is shown in table 660 of FIG. 6, which confirms that a hint is appended to the incoming query. In this example, the hint would be “no_use_hex_plan” because the incoming query matches the patterned query statement “select * from t1 where a=$$?$$” stored in the hint registry.

In a seventh group of query commands 570, an “alter system remove statement hint” hint command is used to remove the hint paired with the patterned query statement “select * from t1 where a=$$?$$” from the hint registry. The next SELECT statement checks if the hint is removed. As shown in table 670 of FIG. 6, the hint “no_use_hex_plan” paired with the patterned query statement “select * from t1 where a=$$?$$” is indeed removed from the hint registry.

In an eighth group of query commands 580, another incoming query “select * from t1 where a=4567” is received and processed. The next SELECT statement checks if any compilation options are applied to the incoming query. The result is shown in table 680 of FIG. 6, which shows that no hint is appended to the incoming query (e.g., the column of COMPILATION_OPTIONS is empty). This is because the hint paired with the patterned query statement “select * from t1 where a=$$?$$” was removed from the hint registry. As a result, no query statement in the hint registry is found to match the incoming query, and the incoming query is thus not modified by any hint.

### Example 9—Example Plan Cache Management

As described above, a cache manager (e.g., the cache manager 140) can be configured to manage a plan cache (e.g., the plan cache 192) so that query plans that are more likely to be reused are kept in the plan cache while other less-likely-used query plans can be evicted from the plan cache. Management of plan cache can be more complicated when hints are allowed to modify incoming queries. This is because a query plan generated for an incoming query without a hint is usually different from a query plan generated for the same incoming query that is modified by a hint.

As described herein, different hint commands (e.g., adding a hint, removing a hint, enabling a hint, disabling a hint) can impact the decision making about which query plan should be saved in the plan cache and which query plan in the plan cache should be evicted.

In certain examples, after registering a query statement and a paired hint in the hint registry (e.g., by using the “alter system add statement hint” command), a query plan in the plan cache that was previously compiled based on the query statement (without the hint) can be evicted from the plan cache. For example, after registering a non-patterned query statement “select * from t1 where a=1234” and a paired hint in the hint registry, a query plan in the plan cache that was previously compiled based on the same query statement “select * from t1 where a=1234” (without the hint) can be evicted. This is because if the incoming query is the same query statement “select * from t1 where a=1234.” it will now be appended with a hint, and this modified query cannot reuse the query plan in the plan cache that corresponds to the same query statement without the hint.

As another example, after registering a patterned query statement “select * from t1 where a=$$?$$” and a paired hint in the hint registry, a query plan in the plan cache that was previously compiled based on a query statement (without the hint) that matches the patterned query statement can be evicted. If there are multiple query plans in the plan cache that were compiled based on different query statements (without the hint) matching the patterned query statement, one of them can be selected for eviction. The selection among these multiple query plans can be manually made by the user, or automatically by an eviction algorithm (e.g., selecting randomly, selecting the least recently used, selecting the least frequently used, etc.).

In certain examples, after removing a query statement and a paired hint in the hint registry (e.g., by using the “alter system remove statement hint” command), a query plan in the plan cache that was previously compiled based on the query statement appended with the hint can be evicted from the plan cache. For example, after removing a non-patterned query statement “select * from t1 where a=2345” and a paired hint from the hint registry, a query plan in the plan cache that was previously compiled based on the same query statement “select * from t1 where a=2345” appended with the hint can be evicted. This is because if the incoming query is the same query statement “select * from t1 where a=2345,” it will be now processed as it is (without a hint), and this query cannot reuse the query plan in the plan cache that corresponds to the same query statement appended with the hint.

As another example, after removing a patterned query statement “select * from t1 where a=$$?$$” and a paired hint from the hint registry, a query plan in the plan cache that was previously compiled based on a query statement that matches the patterned query statement (and appended with the hint) can be evicted. If there are multiple query plans in the plan cache that were compiled based on different query statements matching the patterned query statement (and appended with the hint), one of them can be selected for eviction. The selection among these multiple query plans can be manually made by the user, or automatically by an eviction algorithm (e.g., selecting randomly, selecting the least recently used, selecting the least frequently used, etc.).

In certain examples, if a hint paired with a query statement in the hint registry is switched from the disabled status to the enabled status (e.g., by using the “alter system enable statement hint” command), a query plan in the plan cache that was previously compiled based on the query statement (without the hint) can be evicted from the plan cache, similar to the steps taken after registering the query statement and the paired hint in the hint registry.

In certain examples, if a hint paired with a query statement in the hint registry is switched from the enabled status to the disabled status (e.g., by using the “alter system disable statement hint” command), a query plan in the plan cache that was previously compiled based on the query statement appended with the hint can be evicted from the plan cache, similar to the steps taken after removing the query statement and the paired hint from the hint registry.

On the other hand, if a hint paired with a query statement in the hint registry is already disabled before removing the hint and the query statement from the hint registry, then such removal may not cause eviction of any query plan from the plan cache. This is because a query plan in the plan cache that was previously compiled is based on the query statement without the hint (since the hint was disabled). Thus, after removing the hint and the paired query statement from the hint registry, an incoming query that matches the query statement will still be processed without the hint, thus can reuse the same query plan in the plan cache.

### Example 10—Example Advantages

A number of advantages can be achieved via the technologies described herein.

As described above, hints can be helpful in query optimization by providing additional information or instructions to the query optimizer. However, conventional technologies only allow users can add hints to literal queries or queries having specified objects individually. As such, it would be impossible to apply a hint to many literal queries since the literal part of the literal queries can change from query to query. Further, the hint feature could not be used for queries containing temporary objects, which can be created in runtime and whose names can vary during each run. The technologies described herein, for the first time, support patterned query statements with hints. Such an innovative feature allows users to apply hints more efficiently to a bulk of literal queries and/or queries containing temporary objects, thus reducing time and overall costs of query processing, and potentially reducing human errors introduced when entering the hint commands.

Further, the technologies described herein can improve the plan cache management by taking into account user actions on hints. Particularly, users' hint commands (e.g., adding a hint, removing a hint, enabling a hint, disabling a hint, etc.) can trigger selective eviction of query plans in the plan cache that are deemed to be likely incompatible with incoming queries based on compilation options (e.g., with hints or without hints). As a result, the plan cache can be effectively used for both regular queries without hints and queries modified by hints, thus improving the overall performance of query optimization.

### Example 11—Example Computing Systems

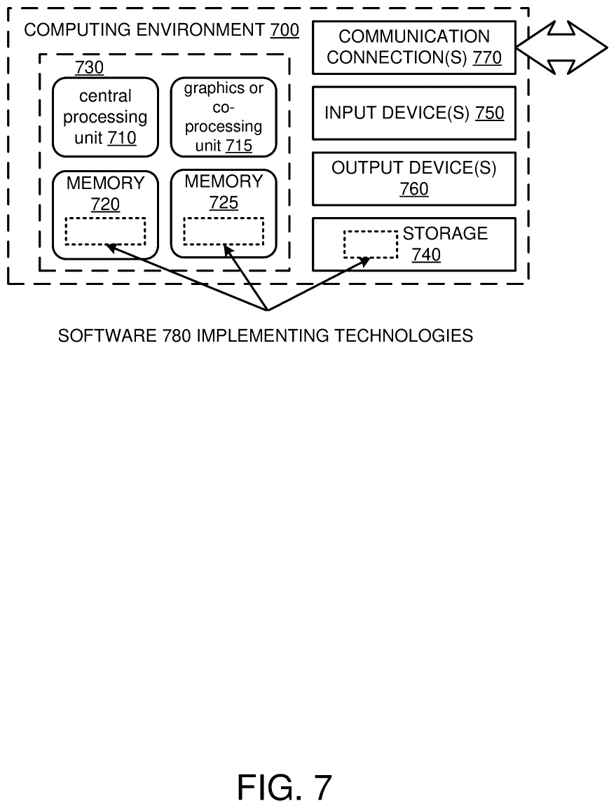

FIG. 7 depicts an example of a suitable computing system 700 in which the described innovations can be implemented. The computing system 700 is not intended to suggest any limitation as to scope of use or functionality of the present disclosure, as the innovations can be implemented in diverse computing systems.

With reference to FIG. 7, the computing system 700 includes one or more processing units 710, 715 and memory 720, 725. In FIG. 7, this basic configuration 730 is included within a dashed line. The processing units 710, 715 can execute computer-executable instructions, such as for implementing the features described in the examples herein (e.g., the method 200). A processing unit can be a general-purpose central processing unit (CPU), processor in an application-specific integrated circuit (ASIC), or any other type of processor. In a multi-processing system, multiple processing units can execute computer-executable instructions to increase processing power. For example, FIG. 7 shows a central processing unit 710 as well as a graphics processing unit or co-processing unit 715. The tangible memory 720, 725 can be volatile memory (e.g., registers, cache, RAM), non-volatile memory (e.g., ROM, EEPROM, flash memory, etc.), or some combination of the two, accessible by the processing unit(s) 710, 715. The memory 720, 725 can store software 780 implementing one or more innovations described herein, in the form of computer-executable instructions suitable for execution by the processing unit(s) 710, 715.

A computing system 700 can have additional features. For example, the computing system 700 can include storage 740, one or more input devices 750, one or more output devices 760, and one or more communication connections 770, including input devices, output devices, and communication connections for interacting with a user. An interconnection mechanism (not shown) such as a bus, controller, or network can interconnect the components of the computing system 700. Typically, operating system software (not shown) can provide an operating environment for other software executing in the computing system 700, and coordinate activities of the components of the computing system 700.

The tangible storage 740 can be removable or non-removable, and includes magnetic disks, magnetic tapes or cassettes, CD-ROMs, DVDs, or any other medium which can be used to store information in a non-transitory way and which can be accessed within the computing system 700. The storage 740 can store instructions for the software implementing one or more innovations described herein.

The input device(s) 750 can be an input device such as a keyboard, mouse, pen, or trackball, a voice input device, a scanning device, touch device (e.g., touchpad, display, or the like) or another device that provides input to the computing system 700. The output device(s) 760 can be a display, printer, speaker, CD-writer, or another device that provides output from the computing system 700.

The communication connection(s) 770 can enable communication over a communication medium to another computing entity. The communication medium can convey information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the context of computer-executable instructions, such as those included in program modules, being executed in a computing system on a target real or virtual processor (e.g., which is ultimately executed on one or more hardware processors). Generally, program modules or components can include routines, programs, libraries, objects, classes, components, data structures, etc. that perform particular tasks or implement particular abstract data types. The functionality of the program modules can be combined or split between program modules as desired in various embodiments. Computer-executable instructions for program modules can be executed within a local or distributed computing system.

For the sake of presentation, the detailed description uses terms like “determine” and “use” to describe computer operations in a computing system. These terms are high-level descriptions for operations performed by a computer, and should not be confused with acts performed by a human being. The actual computer operations corresponding to these terms vary depending on implementation.

### Example 12—Computer-Readable Media

Any of the computer-readable media herein can be non-transitory (e.g., volatile memory such as DRAM or SRAM, nonvolatile memory such as magnetic storage, optical storage, or the like) and/or tangible. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing device to perform the method. The technologies described herein can be implemented in a variety of programming languages.

### Example 13—Example Cloud Computing Environment

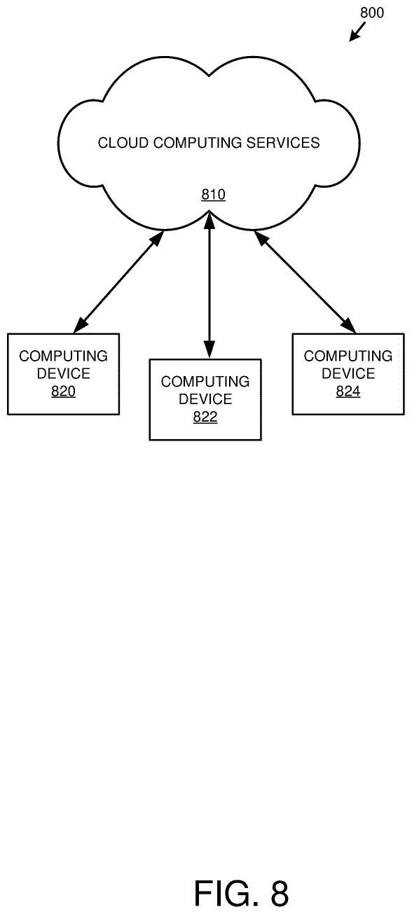

FIG. 8 depicts an example cloud computing environment 800 in which the described technologies can be implemented, including, e.g., the system 100 and other systems herein. The cloud computing environment 800 can include cloud computing services 810. The cloud computing services 810 can comprise various types of cloud computing resources, such as computer servers, data storage repositories, networking resources, etc. The cloud computing services 810 can be centrally located (e.g., provided by a data center of a business or organization) or distributed (e.g., provided by various computing resources located at different locations, such as different data centers and/or located in different cities or countries).

The cloud computing services 810 can be utilized by various types of computing devices (e.g., client computing devices), such as computing devices 820, 822, and 823. For example, the computing devices (e.g., 820, 822, and 824) can be computers (e.g., desktop or laptop computers), mobile devices (e.g., tablet computers or smart phones), or other types of computing devices. For example, the computing devices (e.g., 820, 822, and 824) can utilize the cloud computing services 810 to perform computing operations (e.g., data processing, data storage, and the like).

In practice, cloud-based, on-premises-based, or hybrid scenarios can be supported.

### Example 14—Example Implementations

Although the operations of some of the disclosed methods are described in a particular, sequential order for convenient presentation, such manner of description encompasses rearrangement, unless a particular ordering is required by specific language set forth herein. For example, operations described sequentially can in some cases be rearranged or performed concurrently.

As described in this application and in the claims, the singular forms “a,” “an,” and “the” include the plural forms unless the context clearly dictates otherwise. Additionally, the term “includes” means “comprises.” Further, “and/or” means “and” or “or,” as well as “and” and “or.”

### Example 15—Example Embodiments

Any of the following example embodiments can be implemented.

Example 1. A computer-implemented method comprising: receiving an incoming query statement; searching a query hint registry for a patterned query statement that matches the incoming query statement, wherein a wildcard expression contained in the patterned query statement matches one or more characters of the incoming query statement, wherein the query hint registry comprises a statement hint paired with the patterned query statement; responsive to finding the patterned query statement that matches the incoming query statement, appending the statement hint to the incoming query statement; obtaining a query execution plan for the incoming query statement appended with the statement hint; and executing the query execution plan.

Example 2. The method of example 1, further comprising registering the patterned query statement and statement hint as a pair in the query hint registry.

Example 3. The method of example 2, further comprising, after registering the pair of patterned query statement and the statement hint in the query hint registry, evicting a selected one of a plurality of different query execution plans stored in a query execution plan cache, wherein the plurality of different query execution plans were generated after compiling a plurality of previously received incoming query statements that match the patterned query statement and are without the statement hint.

Example 4. The method of any one of examples 1-3, further comprising removing the patterned query statement and the paired statement hint from the query hint registry.

Example 5. The method of example 4, further comprising, after removing the patterned query statement and the paired statement hint from the query hint registry, evicting a selected one of a plurality of different query execution plans stored in a query execution plan cache, wherein the plurality of different query execution plans were generated after compiling a plurality of previously received incoming query statements that match the patterned query statement and are appended with the statement hint.

Example 6. The method of any one of examples 1-5, wherein the wildcard expression comprises a set of constants in a where clause of the patterned query statement, wherein at least one constant in the set is represented by the one or more characters of the incoming query statement.

Example 7. The method of any one of examples 1-6, wherein the wildcard expression comprises a range in a where clause of the patterned query statement, wherein the range includes a constant represented by the one or more characters of the incoming query statement.

Example 8. The method of any one of examples 1-7, wherein the wildcard expression is included in a from clause of the patterned query statement and matches an object name represented by the one or more characters of the incoming query statement.

Example 9. The method of example 8, wherein the wildcard expression comprises a predefined data type.

Example 10. The method of any one of examples 1-9, wherein the statement hint is a first statement hint, wherein the query hint registry comprises a non-patterned query statement which is identical to the incoming query statement and a second statement hint paired with the non-patterned query statement, wherein the statement hint appended to the incoming query statement is the second statement hint.

Example 11. A computing system, comprising: memory; one or more hardware processors coupled to the memory; and one or more computer readable storage media storing instructions that, when loaded into the memory, cause the one or more hardware processors to perform operations comprising: receiving an incoming query statement; searching a query hint registry for a patterned query statement that matches the incoming query statement, wherein a wildcard expression contained in the patterned query statement matches one or more characters of the incoming query statement, wherein the query hint registry comprises a statement hint paired with the patterned query statement; responsive to finding the patterned query statement that matches the incoming query statement, appending the statement hint to the incoming query statement; obtaining a query execution plan for the incoming query statement appended with the statement hint; and executing the query execution plan.

Example 12. The system of example 11, wherein the operations further comprise registering the patterned query statement and statement hint as a pair in the query hint registry.

Example 13. The system of example 12, wherein the operations further comprise: after registering the pair of patterned query statement and the statement hint in the query hint registry, evicting a selected one of a plurality of different query execution plans stored in a query execution plan cache, wherein the plurality of different query execution plans were generated after compiling a plurality of previously received incoming query statements that match the patterned query statement and are without the statement hint.

Example 14. The system of any one of examples 11-13, wherein the operations further comprise removing the patterned query statement and the paired statement hint from the query hint registry.

Example 15. The system of example 14, wherein the operations further comprise: after removing the patterned query statement and the paired statement hint from the query hint registry, evicting a selected one of a plurality of different query execution plans stored in a query execution plan cache, wherein the plurality of different query execution plans were generated after compiling a plurality of previously received incoming query statements that match the patterned query statement and are appended with the statement hint.

Example 16. The system of any one of examples 11-15, wherein the wildcard expression comprises a set of constants in a where clause of the patterned query statement, wherein at least one constant in the set is represented by the one or more characters of the incoming query statement.

Example 17. The system of any one of examples 11-16, wherein the wildcard expression comprises a range in a where clause of the patterned query statement, wherein the range includes a constant represented by the one or more characters of the incoming query statement.

Example 18. The system of any one of examples 11-17, wherein the wildcard expression is included in a from clause of the patterned query statement and matches an object name represented by the one or more characters of the incoming query statement.

Example 19. The system of example 18, wherein the wildcard expression comprises a predefined data type.

Example 20. One or more non-transitory computer-readable media having encoded thereon computer-executable instructions causing one or more processors to perform a method comprising: receiving an incoming query statement; searching a query hint registry for a patterned query statement that matches the incoming query statement, wherein a wildcard expression contained in the patterned query statement matches one or more characters of the incoming query statement, wherein the query hint registry comprises a statement hint paired with the patterned query statement; responsive to finding the patterned query statement that matches the incoming query statement, appending the statement hint to the incoming query statement; obtaining a query execution plan for the incoming query statement appended with the statement hint; and executing the query execution plan, wherein the wildcard expression is included in a from clause of the patterned query statement and matches an object name represented by the one or more characters of the incoming query statement.

### Example 16—Example Alternatives

The technologies from any example can be combined with the technologies described in any one or more of the other examples. In view of the many possible embodiments to which the principles of the disclosed technology can be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A computer-implemented method comprising:
receiving an incoming query statement;
searching a query hint registry for a patterned query statement that matches the incoming query statement, wherein a wildcard expression contained in the patterned query statement matches one or more characters of the incoming query statement, wherein the query hint registry comprises a statement hint paired with the patterned query statement;
responsive to finding the patterned query statement that matches the incoming query statement, appending the statement hint to the incoming query statement;
obtaining a query execution plan for the incoming query statement appended with the statement hint; and
executing the query execution plan.

2. The method of claim 1, further comprising registering the patterned query statement and statement hint as a pair in the query hint registry.

3. The method of claim 2, further comprising, after registering the pair of patterned query statement and the statement hint in the query hint registry, evicting a selected one of a plurality of different query execution plans stored in a query execution plan cache, wherein the plurality of different query execution plans were generated after compiling a plurality of previously received incoming query statements that match the patterned query statement and are without the statement hint.

4. The method of claim 1, further comprising removing the patterned query statement and the paired statement hint from the query hint registry.

5. The method of claim 4, further comprising, after removing the patterned query statement and the paired statement hint from the query hint registry, evicting a selected one of a plurality of different query execution plans stored in a query execution plan cache, wherein the plurality of different query execution plans were generated after compiling a plurality of previously received incoming query statements that match the patterned query statement and are appended with the statement hint.

6. The method of claim 1, wherein the wildcard expression comprises a set of constants in a where clause of the patterned query statement, wherein at least one constant in the set is represented by the one or more characters of the incoming query statement.

7. The method of claim 1, wherein the wildcard expression comprises a range in a where clause of the patterned query statement, wherein the range includes a constant represented by the one or more characters of the incoming query statement.

8. The method of claim 1, wherein the wildcard expression is included in a from clause of the patterned query statement and matches an object name represented by the one or more characters of the incoming query statement.

9. The method of claim 8, wherein the wildcard expression comprises a predefined data type.

10. The method of claim 1, wherein the statement hint is a first statement hint, wherein the query hint registry comprises a non-patterned query statement which is identical to the incoming query statement and a second statement hint paired with the non-patterned query statement, wherein the statement hint appended to the incoming query statement is the second statement hint.

11. A computing system, comprising:
memory;
one or more hardware processors coupled to the memory; and
one or more computer readable storage media storing instructions that, when loaded into the memory, cause the one or more hardware processors to perform operations comprising:
receiving an incoming query statement;
searching a query hint registry for a patterned query statement that matches the incoming query statement, wherein a wildcard expression contained in the patterned query statement matches one or more characters of the incoming query statement, wherein the query hint registry comprises a statement hint paired with the patterned query statement;
responsive to finding the patterned query statement that matches the incoming query statement, appending the statement hint to the incoming query statement;
obtaining a query execution plan for the incoming query statement appended with the statement hint; and
executing the query execution plan.

12. The system of claim 11, wherein the operations further comprise registering the patterned query statement and statement hint as a pair in the query hint registry.

13. The system of claim 12, wherein the operations further comprise: after registering the pair of patterned query statement and the statement hint in the query hint registry, evicting a selected one of a plurality of different query execution plans stored in a query execution plan cache, wherein the plurality of different query execution plans were generated after compiling a plurality of previously received incoming query statements that match the patterned query statement and are without the statement hint.

14. The system of claim 11, wherein the operations further comprise removing the patterned query statement and the paired statement hint from the query hint registry.

15. The system of claim 14, wherein the operations further comprise: after removing the patterned query statement and the paired statement hint from the query hint registry, evicting a selected one of a plurality of different query execution plans stored in a query execution plan cache, wherein the plurality of different query execution plans were generated after compiling a plurality of previously received incoming query statements that match the patterned query statement and are appended with the statement hint.

16. The system of claim 11, wherein the wildcard expression comprises a set of constants in a where clause of the patterned query statement, wherein at least one constant in the set is represented by the one or more characters of the incoming query statement.

17. The system of claim 11, wherein the wildcard expression comprises a range in a where clause of the patterned query statement, wherein the range includes a constant represented by the one or more characters of the incoming query statement.

18. The system of claim 11, wherein the wildcard expression is included in a from clause of the patterned query statement and matches an object name represented by the one or more characters of the incoming query statement.

19. The system of claim 18, wherein the wildcard expression comprises a predefined data type.

20. One or more non-transitory computer-readable media having encoded thereon computer-executable instructions causing one or more processors to perform a method comprising:
receiving an incoming query statement;
searching a query hint registry for a patterned query statement that matches the incoming query statement, wherein a wildcard expression contained in the patterned query statement matches one or more characters of the incoming query statement, wherein the query hint registry comprises a statement hint paired with the patterned query statement;
responsive to finding the patterned query statement that matches the incoming query statement, appending the statement hint to the incoming query statement;
obtaining a query execution plan for the incoming query statement appended with the statement hint; and
executing the query execution plan,
wherein the wildcard expression is included in a from clause of the patterned query statement and matches an object name represented by the one or more characters of the incoming query statement.
